(19) United States
(12) Patent Application Publication
(10) Pub. No.: US 2012/0069479 A1
(43) Pub. Date: Mar. 22, 2012

(54) POWER TRANSISTOR DEVICE WITH ELECTROSTATIC DISCHARGE PROTECTION AND LOW DROPOUT REGULATOR USING SAME

(75) Inventor: Jian-Hsing LEE, Hsinchu (TW)

(73) Assignee: Richtek Technology Corporation

(21) Appl. No.: 12/884,588

(22) Filed: Sep. 17, 2010

(51) Int. Cl. H02H 9/04

(52) U.S. Cl. 361/56

(57) ABSTRACT

The present invention discloses a power transistor device and a low dropout regulator (LDO) with electrostatic discharge protection. The power transistor device includes: a P-type metal oxide semiconductor (PMOS) field effect transistor (FET), having a source and a drain electrically connected to a voltage input terminal and a voltage output terminal respectively; and an electrostatic discharge protection device, electrically connected to the voltage input terminal and the voltage output terminal, for providing an electrostatic discharge path to protect the PMOSFET.

### BACKGROUND OF THE INVENTION

1. Field of Invention

The present invention relates to a power transistor device with electrostatic discharge protection and a low dropout regulator using the power transistor device, wherein an electrostatic discharge path is provided to protect the power transistor device.

2. Description of Related Art

FIG. 1 shows a schematic diagram of a prior art low dropout (LDO) regulator. An LDO regulator 100 is a linear regulator for converting an input voltage Vin to an output voltage Vout; its basic structure is as shown in this figure, which includes an error amplifier 10 and a power transistor device 20. The error amplifier 10 receives an output voltage sampled signal which is obtained from the voltage of a resistor R2; resistors R1 and R2 are connected in series between the output voltage Vout and ground. The error amplifier 10 compares the output voltage sampled signal with a reference signal Vref to generate an error amplification signal, and outputs the error amplification signal to the gate of a PMOSFET (P-type metal oxide semiconductor field effect transistor) in the power transistor device 20 to control the conduction between the source and the drain of the PMOSFET, that is, to control the conversion from the input voltage Vin to the output voltage Vout. A cross-section view of the PMOSFET of the power transistor device 20 is shown in FIG. 2. As shown by the cross-section view, the PMOSFET is formed on a P-type substrate (P-sub) 21. A high voltage N-type well (NW) 23 and a high voltage P-type well (PW) 24 which are adjacent to each other are formed below the top surface of the P-sub 21. Shallow trench isolation (STI) regions 25, an N+ body 26, a P+ source 27, and a P+ drain 29 are formed in the wells 23 and 24; and a gate 28 is formed on the top surface.

Referring to FIGS. 1 and 2, the power transistor device 20 has a contact pad 1 which is an output terminal of the power transistor device 20; the contact pad 1 may be touched by a human body or may contact various electrical fields in various applications and test environments. Therefore, electrical charges may be accumulated on the contact pad 1 to generate an electrostatic voltage, or the contact pad 1 may contact a high electrostatic voltage directly. When the electrostatic voltage is so high to an extent that the power transistor device 20 can not withstand, the electrostatic voltage will discharge through a discharge path, such as a path indicated by the dash line in FIG. 2. This will result in mis-operation of the circuit or serious damages to the device.

In view of the foregoing, the present invention provides a power transistor device with electrostatic discharge protection and a low dropout regulator using the power transistor device, to overcome drawbacks in the prior art.

### SUMMARY OF THE INVENTION

The first objective of the present invention is to provide a power transistor device with electrostatic discharge protection.

The second objective of the present invention is to provide an LDO regulator employing the power transistor device with electrostatic discharge protection.

To achieve the objective mentioned above, from one perspective, the present invention provides a power transistor device with electrostatic discharge protection comprising: a PMOSFET having a source and a drain electrically connected to a voltage input terminal and a voltage output terminal, respectively; and an electrostatic discharge protection device electrically connected to the voltage input terminal and the voltage output terminal, for providing an electrostatic discharge path such that the electrostatic voltage of the voltage output terminal discharges through the electrostatic discharge path, to protect the PMOSFET; wherein the voltage output terminal includes a contact pad for providing an electrical connection to a load circuit.

In a preferred embodiment of the power transistor device, the electrostatic discharge protection device further includes a deep N-well (NW) or an N-type buried layer (NBL).

In one embodiment, the electrostatic discharge protection device includes an NPN bipolar junction transistor (BJT) having an emitter and a collector electrically connected to the voltage output terminal and the voltage input terminal, respectively, and having a base controlled by the voltage output terminal.

In another embodiment, the electrostatic discharge protection device includes an NMOSFET (N-type metal oxide semiconductor field effect transistor) having a drain and a source electrically connected to the voltage output terminal and the voltage input terminal, respectively, and having a gate which is connected to ground or which is controlled by the voltage output terminal.

In yet another embodiment, the electrostatic discharge protection device includes a silicon controlled rectifier (SCR) having a cathode and an anode electrically connected to the voltage output terminal and the voltage input terminal, respectively, and having a gate controlled by the voltage output terminal.

From another perspective, the present invention provides a LDO regulator with electrostatic discharge protection for converting an input voltage of a voltage input terminal to an output voltage of a voltage output terminal, the LDO regulator with electrostatic discharge protection comprising: an error amplifier circuit generating an error amplified signal according to an output voltage sampled signal and a reference signal, wherein the output voltage sampled signal is sampled from the output voltage; and a power transistor device including: a PMOSFET having a source and a drain electrically connected to the voltage input terminal and the voltage output terminal, and having a gate controlled by the error amplified signal; and an electrostatic discharge protection device electrically connected to the voltage input terminal and the voltage output terminal, for providing an electrostatic discharge path such that the electrostatic voltage of the voltage output terminal discharges through the electrostatic discharge path, to protect the PMOSFET; wherein the voltage output terminal includes a contact pad for providing an electrical connection to a load circuit.

In the aforementioned LDO regulator, the electrostatic discharge protection device further includes a deep N-well (NW) or an N-type buried layer (NBL).

In one embodiment of the aforementioned LDO regulator, the electrostatic discharge protection device includes an NPN bipolar junction transistor (BJT) having an emitter and a collector electrically connected to the voltage output terminal and the voltage input terminal, respectively, and having a base controlled by the voltage output terminal.

In another embodiment of the aforementioned LDO regulator, the electrostatic discharge protection device includes an N-type metal oxide semiconductor (NMOS) FET having a drain and a source electrically connected to the voltage output terminal and the voltage input terminal, respectively, and having a gate which is connected to ground or which is controlled by the voltage output terminal.

In yet another embodiment of the aforementioned LDO regulator, the electrostatic discharge protection device includes a silicon controlled rectifier (SCR) having a cathode and an anode electrically connected to the voltage output terminal and the voltage input terminal, respectively, and having a gate controlled by the voltage output terminal.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art LDO regulator.

FIG. 2 shows a cross-section view of the PMOSFET of the power transistor device 20 in FIG. 1.

FIGS. 3 and 4 show a first embodiment of the present invention.

FIGS. 5 and 6 show a second embodiment of the present invention.

FIGS. 7 and 8 show a third embodiment of the present invention.

FIGS. 9 and 10 show a fourth embodiment of the present invention.

FIG. 11 shows another embodiment of the power transistor device 30.

FIG. 12 shows another embodiment of the power transistor device 40.

FIG. 13 shows another embodiment of the power transistor device 50.

FIG. 14 shows another embodiment of the power transistor device 60.

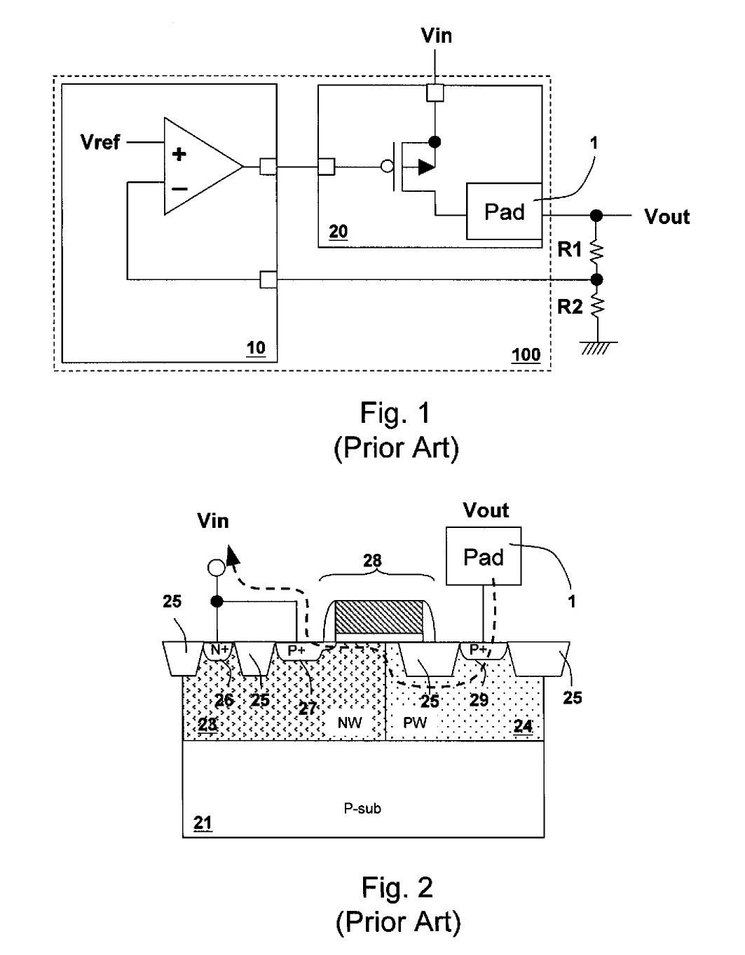

### DESCRIPTION OF THE PREFERRED EMBODIMENTS

The spirit of the present invention is to provide an N-type channel device which forms a discharge path, to solve the problems caused by the electrostatic charges in a P-type power transistor.

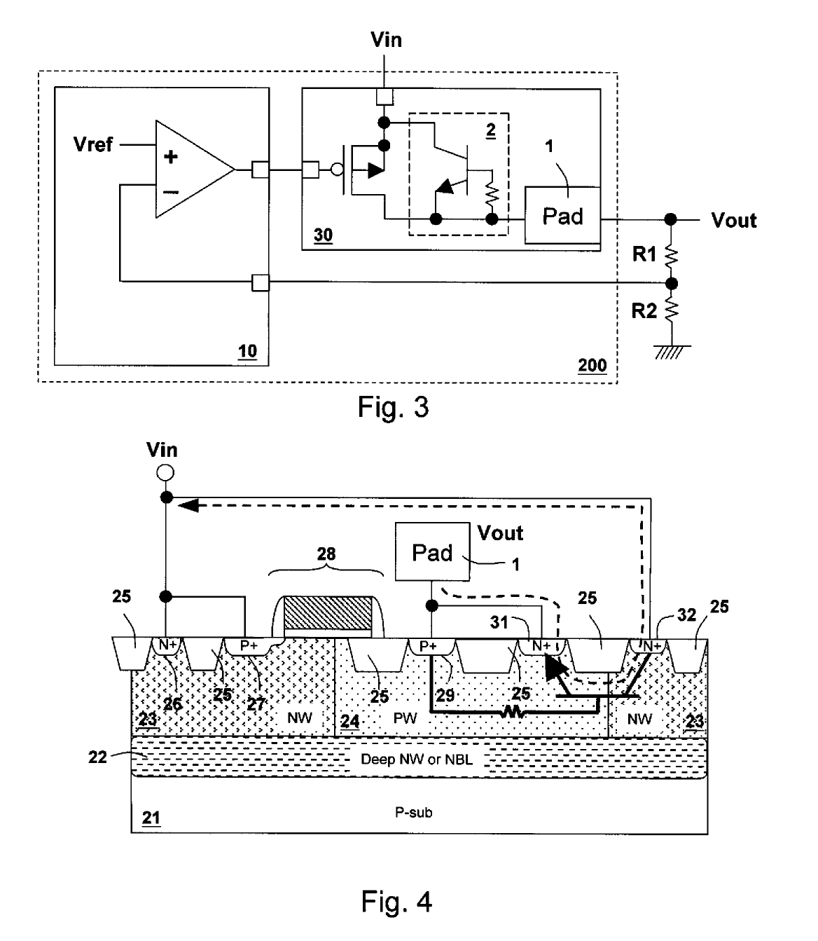

FIGS. 3 and 4 show a first embodiment of the present invention. As shown in FIG. 3, an LDO regulator 200 includes an error amplifier circuit 10 and a power transistor device 30. The present invention is different from the prior art in that, besides a PMOSFET, the power transistor device 30 includes an electrostatic discharge protection device 2. The source and the drain of the PMOSFET are electrically connected to the voltage input terminal Vin and the voltage output terminal Vout, respectively. In this embodiment, the electrostatic discharge protection device 2 includes an NPN bipolar junction transistor (BJT) which has an emitter 31 and a collector 32 electrically connected to the voltage output terminal Vout and the voltage output terminal Vin, respectively, and has a base controlled by the voltage output terminal Vout. When the contact pad 1 of the voltage output terminal Vout contacts an electrostatic voltage, the electrostatic voltage can be discharged through a path from the collector 32 to the emitter 31 of the electrostatic discharge protection device NPNBJT, to protect the PMOSFET.

FIG. 4 shows a cross-section view of the power transistor device 30 of the first embodiment. Among the differences between this embodiment and the prior art, one difference is that this embodiment further includes a deep N-type well (deep NW) or an N-type buried layer (NBL) 22. The deep NW or NBL 22 is formed between a P-type substrate (P-sub) 21 and a high voltage N-type well (NW) 23 and a high voltage P-type well (PW) 24, for isolating the power transistor device 30 from the P-type substrate 21. The N+ type emitter 31, the N+ type collector 32, and the P+ type base are respectively shown in the figure. FIG. 4 also shows symbols of the NPNBJT and a resistor to indicate the relationship among the areas in the cross-section view from circuit perspective. The dash arrow line indicates the discharge path when the contact pad contacts an electrostatic voltage. Because the NPNBJT provides an additional electrostatic discharge path, the electrostatic voltage will not impact the function of the PMOSFET and will not damage the structure of the PMOSFET.

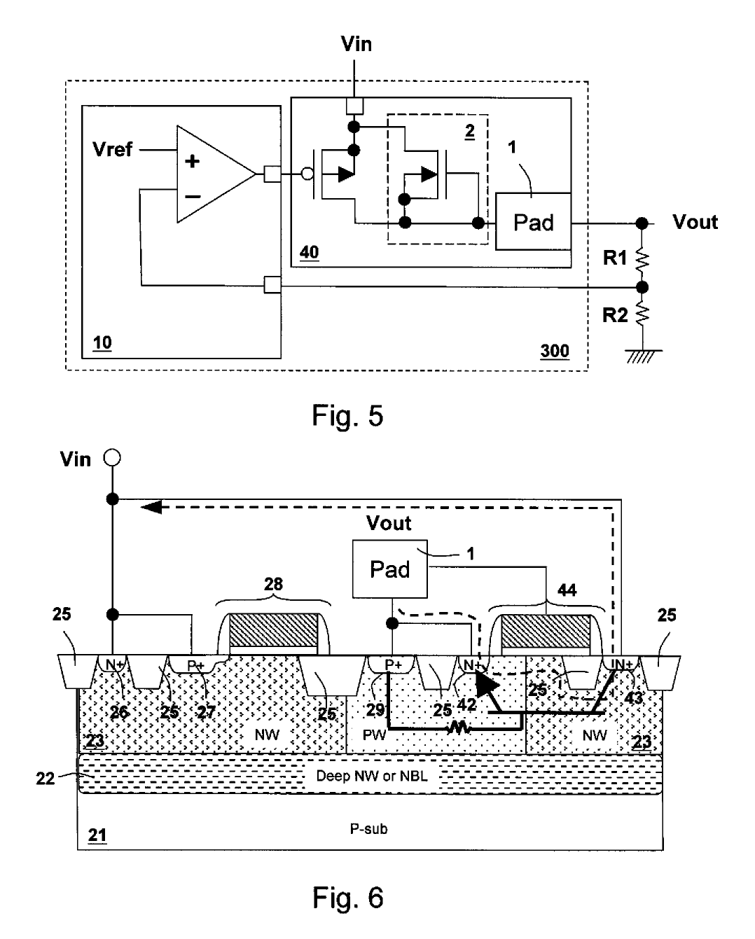

FIGS. 5 and 6 show a second embodiment of the present invention. As shown in FIG. 5, an LDO regulator 300 includes an error amplifier circuit 10 and a power transistor device 40. The power transistor device 40 includes a PMOSFET and an electrostatic discharge protection device 2. In this embodiment, the electrostatic discharge protection device 2 includes an NMOSFET which has a drain 42 and a source 43 electrically connected to the voltage output terminal Vout and the voltage input terminal Vin, respectively, and has a gate 44 controlled by the voltage output terminal Vout. When the contact pad 1 of the voltage output terminal Vout contacts an electrostatic voltage, the electrostatic voltage can be discharged through a path from the drain 42 to the source 43 provided by a parasitic NPNBJT of the electrostatic discharge protection device NMOSFET, to protect the PMOSFET.

FIG. 6 shows a cross-section view of the power transistor device 40 of the second embodiment. The deep NW or NBL 22 is formed between the P-type substrate (P-sub) 21 and the high voltage N-type well (NW) 23 and the high voltage P-type well (PW) 24 for isolating the power transistor device 40 from the P-type substrate 21. The N+ type drain 42, the N+ type source 43, and the gate 44 are respectively shown in the figure. FIG. 6 also shows a symbol of the parasitic NPNBJT of the NMOSFET to indicate the relationship among the areas in the cross-section view from circuit perspective. The dash arrow line indicates the discharge path when the contact pad 1 contacts an electrostatic voltage. Because the parasitic NPNBJT of the NMOSFET provides an additional electrostatic discharge path, the electrostatic voltage will not impact the function of the PMOSFET and will not damage the structure of the PMOSFET.

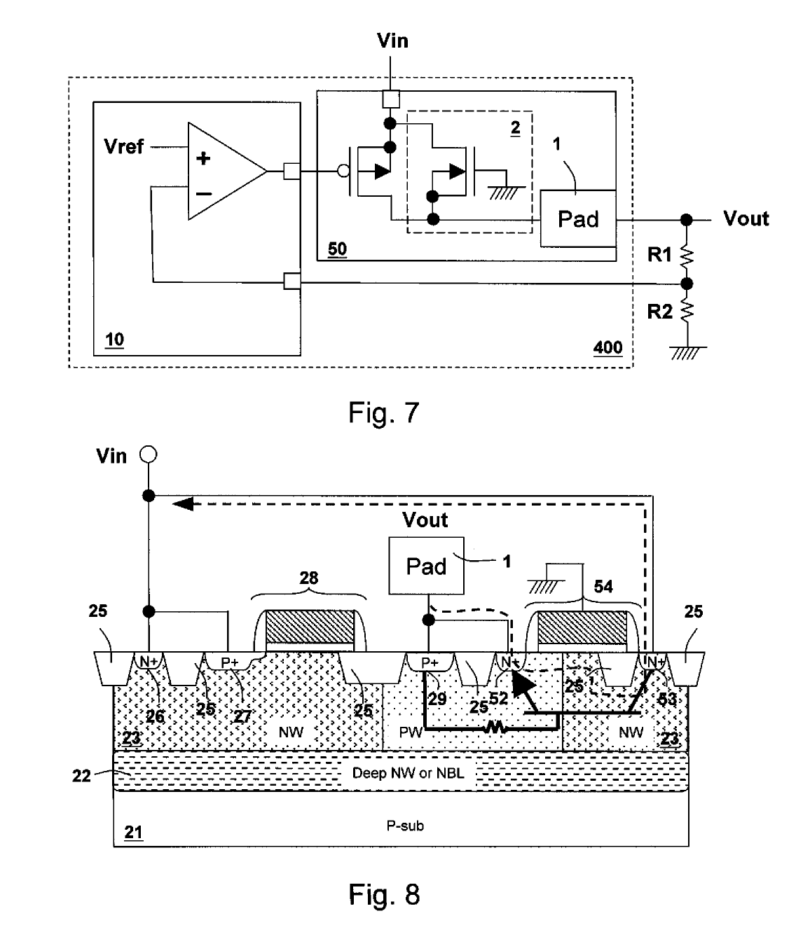

FIGS. 7 and 8 show a third embodiment of the present invention. As shown in FIG. 7, an LDO regulator 400 includes an error amplifier circuit 10 and a power transistor device 50. The power transistor device 50 includes a PMOSFET and an electrostatic discharge protection device 2. In this embodiment, the electrostatic discharge protection device 2 includes an NMOSFET which has a drain 52 and a source 53 electrically connected to the voltage output terminal Vout and the voltage input terminal Vin, respectively, and has a gate 54 electrically connected to ground. When the contact pad 1 of the voltage output terminal Vout contacts an electrostatic voltage, the electrostatic voltage can be discharged through a path from the drain 52 to the source 53 provided by a parasitic NPNBJT of the electrostatic discharge protection device NMOSFET, to protect the PMOSFET.

FIG. 8 shows a cross-section view of the power transistor device 50 of the third embodiment. The deep NW or NBL 22 is formed between the P-type substrate (P-sub) 21 and the high voltage N-type well (NW) 23 and the high voltage P-type well (PW) 24 for isolating the power transistor device 50 from the P-type substrate 21. The N+ type drain 52, the N+ type source 53, and the gate 54 are respectively shown in the figure. FIG. 8 also shows a symbol of the parasitic NPNBJT of the NMOSFET to indicate the relationship among the areas in the cross-section view from circuit perspective. The dash arrow line indicates the discharge path when the contact pad 1 contacts an electrostatic voltage. Because the parasitic NPNBJT of the NMOSFET provides an additional electrostatic discharge path, the electrostatic voltage will not impact the function of the PMOSFET and will not damage the structure of the PMOSFET.

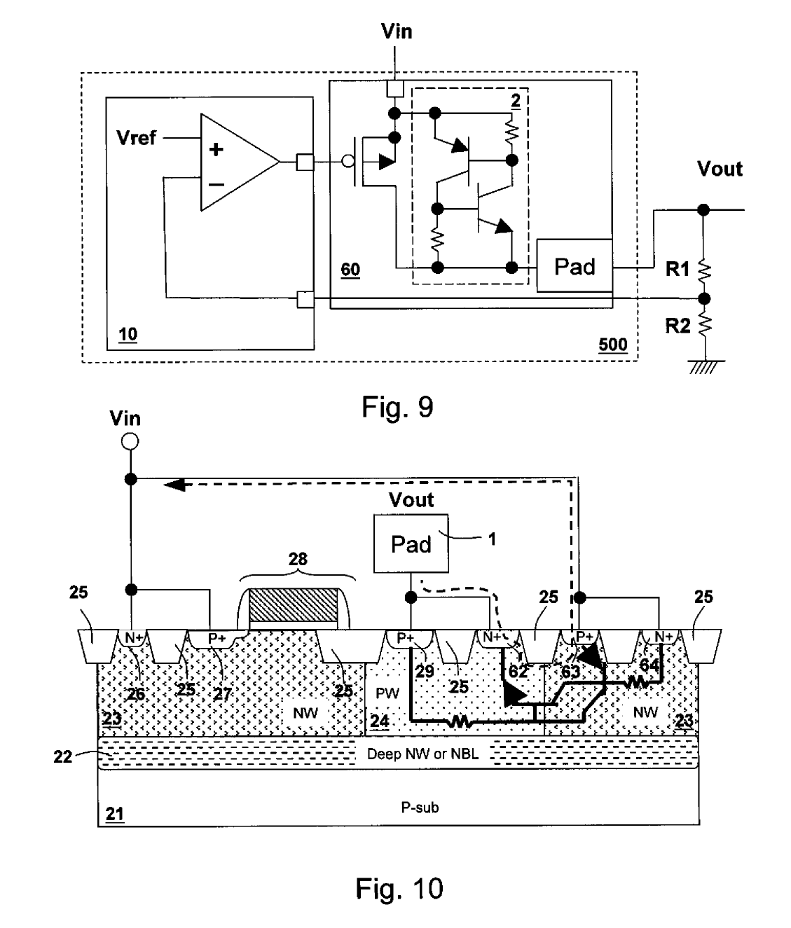

FIGS. 9 and 10 show a fourth embodiment of the present invention. As shown in FIG. 9, an LDO regulator 500 includes an error amplifier circuit 10 and a power transistor device 60. The power transistor device 60 includes a PMOSFET and an electrostatic discharge protection device 2. In this embodiment, the electrostatic discharge protection device 2 includes a silicon controlled rectifier (SCR) which has a cathode 62 and an anode 63 electrically connected to the voltage output terminal Vout and the voltage input terminal Vin, respectively, and has a gate electrically connected to the voltage output terminal Vout through a resistor connected in series. When the contact pad 1 of the voltage output terminal Vout contacts an electrostatic voltage, the electrostatic voltage can be discharged through a path from the cathode 62 to the anode 63 provided by the electrostatic discharge protection device SCR, to protect the PMOSFET.

FIG. 10 shows a cross-section view of the power transistor device 60 of the fourth embodiment. The deep NW or NBL 22 is formed between the P-type substrate (P-sub) 21 and the high voltage N-type well (NW) 23 and the high voltage P-type well (PW) 24 for isolating the power transistor device 60 and the P-type substrate 21. The cathode 62, the anode 63, and the gate of the SCR are respectively shown in the figure. FIG. 10 also shows symbols of the BJTs which form the SCR to indicate the relationship among the areas in the cross-section view from circuit perspective. The dash arrow line indicates the discharge path when the contact pad 1 contacts an electrostatic voltage. Because the cathode 62 to the anode 63 of the SCR provides an additional electrostatic discharge path, the electrostatic voltage will not impact the function of the PMOSFET and will not damage the structure of the PMOSFET.

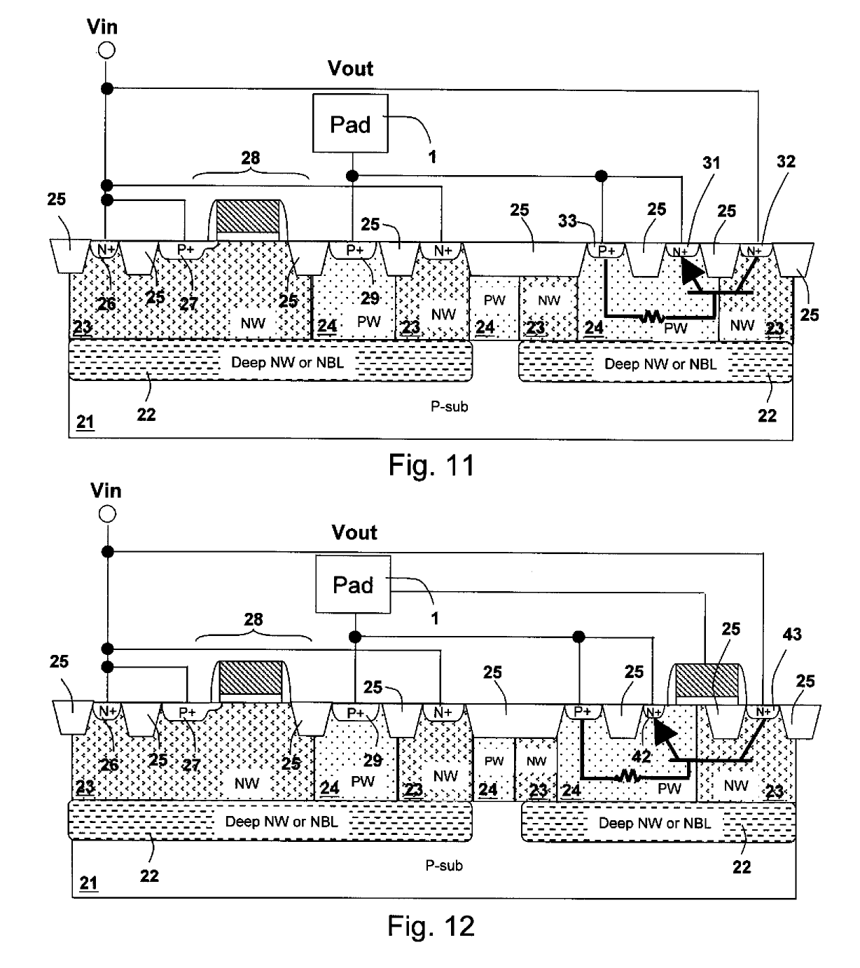

FIG. 11 shows another embodiment of the power transistor device 30. This embodiment is different from FIG. 4 in that, an STI 25, and a high voltage N-type well 23 and a high voltage P-type well 24 are provided to isolate the PMOSFET and the NPNBJT from each other.

FIG. 12 shows another embodiment of the power transistor device 40. This embodiment is different from FIG. 6 in that, an STI 25, and a high voltage N-type well 23 and a high voltage P-type well 24 are provided to isolate the PMOSFET and the NMOSFET from each other.

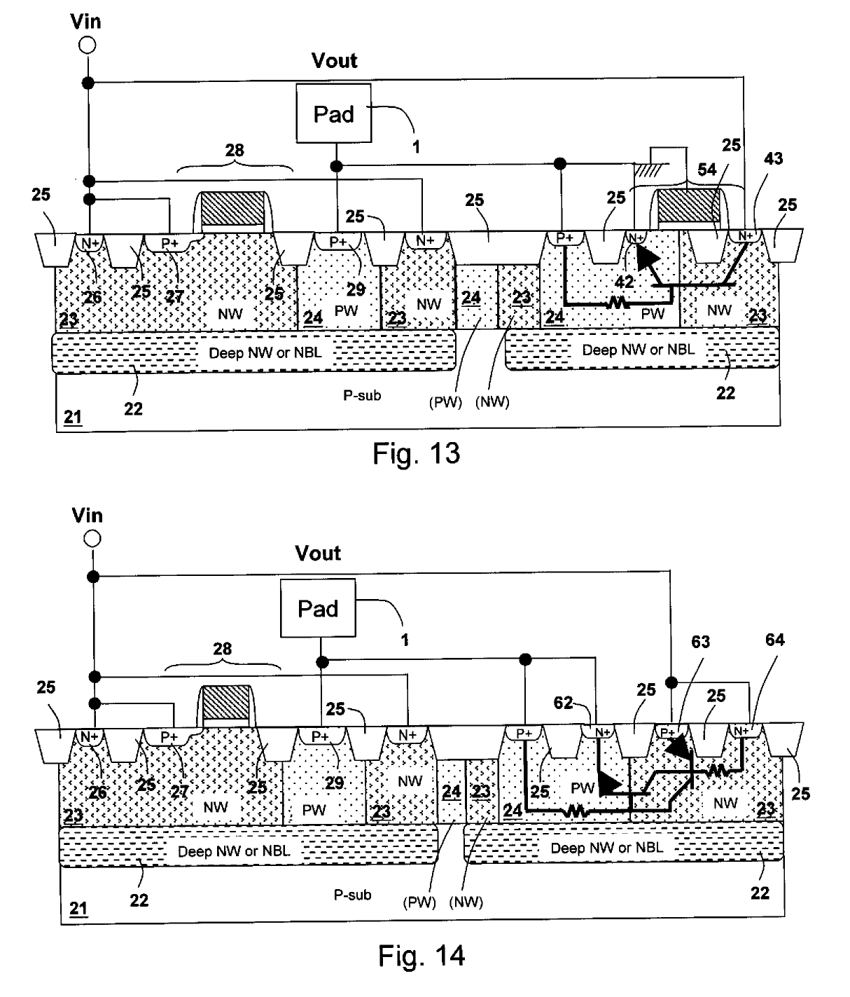

As shown in FIG. 13, the power transistor device 50 shown in FIG. 8 may also be modified to a semiconductor structure similar to the one shown in FIG. 12.

FIG. 14 shows another embodiment of the power transistor device 60. This embodiment is different from FIG. 10 in that, an STI 25, and a high voltage N-type well 23 and a high voltage P-type well 24 are provided to isolate the PMOSFET and the SCR from each other.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch or the like. As another example, the shallow trench isolation region can be replaced by a LOCOS (local oxidation of silicon) region, etc. In view of the foregoing, the spirit of the present invention should cover all such and other modifications and variations, which should be interpreted to fall within the scope of the following claims and their equivalents.

What is claimed is:

1. A power transistor device with electrostatic discharge protection, comprising:
a P-type metal oxide semiconductor (PMOS) field effect transistor (FET) having a source and a drain electrically connected to a voltage input terminal and a voltage output terminal, respectively; and
an electrostatic discharge protection device electrically connected to the voltage input terminal and the voltage output terminal, for providing an electrostatic discharge path such that the electrostatic voltage at the voltage output terminal discharges through the electrostatic discharge path, to protect the PMOSFET,
wherein the voltage output terminal includes a contact pad for providing an electrical connection to a load circuit.

2. The power transistor device of claim 1, wherein the electrostatic discharge protection device further includes a deep N-well or an N-type buried layer.

3. The power transistor device of claim 1, wherein the electrostatic discharge protection device includes an NPN bipolar junction transistor (BJT) having an emitter and a collector electrically connected to the voltage output terminal and the voltage input terminal, respectively, and having a base controlled by the voltage output terminal.

4. The power transistor device of claim 1, wherein the electrostatic discharge protection device includes an N-type metal oxide semiconductor (NMOS) FET having a drain and a source electrically connected to the voltage output terminal and the voltage input terminal, respectively, and having a gate which is connected to ground or which is controlled by the voltage output terminal.

5. The power transistor device of claim 1, wherein the electrostatic discharge protection device includes a silicon controlled rectifier (SCR) having a cathode and an anode electrically connected to the voltage output terminal and the voltage input terminal, respectively, and having a gate controlled by the voltage output terminal.

6. A low dropout (LDO) regulator with electrostatic discharge protection, for converting an input voltage at a voltage input terminal to an output voltage at a voltage output terminal, the LDO regulator comprising:
an error amplifier circuit generating an error amplified signal according to an output voltage sampled signal and a reference signal, wherein the output voltage sampled signal is sampled from the output voltage; and
a power transistor device including:
a P-type metal oxide semiconductor (PMOS) field effect transistor (FET) having a source and a drain electrically connected to the voltage input terminal and the voltage output terminal, respectively, and having a gate controlled by the error amplified signal; and
an electrostatic discharge protection device electrically connected to the voltage input terminal and the voltage output terminal, for providing an electrostatic discharge path such that the electrostatic voltage of the voltage output terminal discharges through the electrostatic discharge path, to protect the PMOSFET, wherein the voltage output terminal includes a contact pad for providing an electrical connection to a load circuit.

7. The LDO regulator of claim 6, wherein the electrostatic discharge protection device further includes a deep N-well or an N-type buried layer.

8. The LDO regulator of claim 6, wherein the electrostatic discharge protection device includes an NPN bipolar junction transistor (BJT) having an emitter and a collector electrically connected to the voltage output terminal and the voltage input terminal, respectively, and having a base controlled by the voltage output terminal.

9. The LDO regulator of claim 6, wherein the electrostatic discharge protection device includes an N-type metal oxide semiconductor (NMOS) FET having a drain and a source electrically connected to the voltage output terminal and the voltage input terminal, respectively, and having a gate which is connected to ground or which is controlled by the voltage output terminal.

10. The LDO regulator of claim 6, wherein the electrostatic discharge protection device includes a silicon controlled rectifier (SCR) having a cathode and an anode electrically connected to the voltage output terminal and the voltage input terminal, respectively, and having a gate controlled by the voltage output terminal.
